(19) United States
(12) Patent Application Publication
(10) Pub. No.: US 2026/0235183 A1
(43) Pub. Date: Aug. 13, 2026

(54) AIR SPRING FOR VEHICLE

(71) Applicant: ILJIN Co., LTD., Gyeongju-si Gyeongsangbuk-do (KR)

(72) Inventors: Sewoong JEONG, Ulsan (KR); Jonghyung SEO, Seoul (KR); Haseok OH, Gwangju (KR); Byunghwan KIM, Ulsan (KR); Sangwoo KIM, Gyeongsangnam-do (KR); Junghan KIM, Busan (KR)

(73) Assignee: ILJIN Co., LTD., Gyeongju-si Gyeongsangbuk-do (KR)

(21) Appl. No.: 19/536,437

(22) Filed: Feb. 11, 2026

(30) Foreign Application Priority Data
Feb. 12, 2025 (KR) 10-2025-0017788

(51) Int. Cl. F16F 9/04; B60G 11/27; B60G 17/08; F16F 9/05; F16F 9/32

(52) U.S. Cl. CPC F16F 9/0454; B60G 11/27; B60G 17/08; F16F 9/05; F16F 9/057; F16F 9/3242; B60G 2202/152

(57) ABSTRACT

According to the present disclosure, an air spring for a vehicle includes a sleeve and an end member to which beads and formed at one end of the sleeve are coupled. The end member has contact surfaces and configured to come into contact with the beads. At least one protrusion and at least one protrusion are formed in the contact surfaces, respectively, so as to protrude toward the beads, respectively. When the sleeve is pressed against the contact surfaces by a pressure of compressed air in the sleeve, the sleeve is compressed and deformed by the at least one protrusion and the at least one protrusion so that relative rotations between the sleeve and the contact surfaces are prevented.

### CROSS-REFERENCE TO RELATED APPLICATION

This application claims priority to Korean Patent Application No. 10-2025-0017788 filed on Feb. 12, 2025, the entire content of which is herein incorporated by reference.

### TECHNICAL FIELD

The present disclosure relates to an air spring for a vehicle, and more particularly, to an air spring for a vehicle which prevents a sealing ring from rotating relative to surrounding members to suppress the sealing ring from being worn due to friction, thereby reducing the risk of air leakage.

### BACKGROUND

A suspension for a vehicle is provided between a vehicle body and a wheel to connect the vehicle body and the wheel as rigid bodies by one or multiple links. The suspension is supported by a spring, a shock absorber and the like in a vertical direction, and serves to appropriately balance a mechanical relative movement between the vehicle body and the wheel.

The suspension needs to satisfy the following basic conditions. That is, the suspension needs to effectively block shocks generated from an unevenness road surface when the vehicle is travelling, thus providing a comfortable ride quality to passengers. The suspension needs to provide driving convenience by appropriately control the shaking of the vehicle body caused by a driving behavior of a driver and the unevenness road surface. Further, when the vehicle travels on the unevenness road surface, the suspension needs to support a vertical load acting on each tire at a contact surface with the unevenness road surface at an appropriate level, thus ensuring the driving operation and stability of the vehicle during turning and braking.

In order to satisfy such conditions, various types of suspensions have been developed and applied to vehicles. In recent years, an air suspension has been widely applied to a deluxe vehicle.

An air spring, which is a constituent element of the air suspension, is arranged on an upper end of the shock absorber (so-called damper). For example, the damper may have a lower end portion connected to a side portion of a wheel of a lower control arm. In the air suspension, a top mount is a constituent element that connects the air spring and the damper to the vehicle body on an upper side of the air spring.

A piston is mounted on the damper. An operation space, which is filled with compressed air, is formed in an interior of the sleeve air-tightly connected between the top mount and the piston. A sealing ring may be used for such an air-tight connection.

However, since the damper rotates with a steering operation by the driver, the sealing ring may rub against surrounding members. This may increase the risk of air leakage.

### SUMMARY

The present disclosure was made to solve the above-mentioned matters, and the present disclosure is for the purpose of providing an air spring for a vehicle which prevents a sealing ring from rotating relative to surrounding members to suppress the sealing ring from being worn due to friction, thereby reducing the risk of air leakage.

According to an example embodiment of the present disclosure, an air spring for a vehicle may include a sleeve 300, and an end member to which beads 320 and 340 formed at one end of the sleeve 300 are coupled. The end member may have ring-shaped contact surfaces 110 and 742 configured to come into contact with the beads 320 and 340. At least one protrusion 112 and at least one protrusion 744 may be formed in the contact surfaces 110 and 742 to protrude toward the beads 320 and 340, respectively. When the sleeve 300 is pressed against the contact surfaces 110 and 742 by a pressure of compressed air in the sleeve 300, the sleeve 300 may be compressed and deformed by the at least one protrusion 112 and the at least one protrusion 744 so that the sleeve 300 and the contact surfaces 110 and 742 are prevented from rotating relative to each other.

In an aspect, the at least one protrusion 112 and the at least one protrusion 744 may include a plurality of protrusions 112 and a plurality of protrusions 744, which are arranged to be spaced apart from each other in a circumferential direction along the contact surfaces 110 and 742, respectively.

In an aspect, each of the plurality of protrusions 112 and each of the plurality of protrusions 744 may have a key shape extending in an axial direction and may be formed in a serration form.

In an aspect, sealing rings 160 and 510 may be provided between the beads 320 and 340 of the sleeve 300 and the end member, respectively.

In an aspect, the end member may be a top mount 100. The top mount 100 may include a first downward extension portion 120 extending downward from a lower surface of the top mount 100, and a second downward extension portion 140 arranged to be spaced apart from the first downward extension portion 120 in a radially outward direction and extending downward from the lower surface of the top mount 100. The bead 320 may be arranged between the first downward extension portion 120 and the second downward extension portion 140. The contact surface 110 is formed on the lower surface of the top mount 100 between the first downward extension portion 120 and the second downward extension portion 140.

In an aspect, the sleeve 300 may further include a radially-inward protruded portion 324 protruding in a radially inward direction. The sealing ring 160 may be installed in a space surrounded by an inner peripheral surface of the sleeve 300, the radially-inward protruded portion 324 and the lower surface of the top mount 100.

In an aspect, the end member may be a piston constituent element. The piston constituent element may include a piston 200 and a sealing ring seat 700. The sealing ring seat 700 may have a mounting surface on which the sealing ring 510 is mounted, and the contact surface 742. The bead 340 may be provided between the sealing ring seat 700 and the piston 200.

In an aspect, the sealing ring seat 700 may include a first outer-diameter portion 720 having a first outer diameter and a second outer-diameter portion 470 having a second outer diameter greater than the first outer diameter. The first outer-diameter portion 720 and the second outer-diameter portion 740 may be continuously arranged to form a stepped portion. The mounting surface may be formed at the stepped portion and the contact surface 742 may be formed on an outer peripheral surface of the second outer-diameter portion 740.

In an aspect, the sleeve 300 may further include a radially-inward protruded portion 344 protruding in the radially inward direction. The sealing ring 510 may be provided in a space surrounded by an inner circumferential surface of the sleeve 300, the radially-inward protruded portion 344 and the stepped portion of the sealing ring seat 700.

According to an example embodiment of the present disclosure, it is possible to prevent a sealing ring from slipping against surrounding members (from rotating relative to the surrounding members), thereby suppressing the sealing ring from being worn due to friction and reducing the risk of air leakage.

### BRIEF DESCRIPTION OF THE DRAWINGS

FIG. 1 is a cross-sectional view of an air spring according to an example embodiment of the present disclosure.

FIG. 2 shows a contact surface formed on a lower surface of a top mount according to an example embodiment of the present disclosure.

FIG. 3 shows a sealing ring seat according to an example embodiment of the present disclosure.

### DETAILED DESCRIPTION

Various modifications may be added to example embodiments of the present disclosure. Specific example embodiments will be described with reference to the drawings. However, the present disclosure is not limited to the specific example embodiments but should be understood as including various modifications, equivalents or alterations, which fall within the scope and the technical sprit of the present disclosure. In descriptions of the drawings, like reference numerals will refer to the same or similar constituent elements. Further, although the terms such as a “first,” a “second,” “A,” and the like used herein may be used to explain various constituent elements, such constituent elements should not be limited by such terms. The above terms may be used to distinguish a constituent element from another constituent element. For example, a first constituent element may be named as a second constituent element in another description of the specification without departing from the scope of the present disclosure. Conversely, the second constituent element may be named as the first constituent element in another description of the specification. The term “and/or” may be used to represent a combination of a plurality of related items described herein or at least one of the plurality of related items. Further, when a constituent element is referred to as being “coupled” or “connected” to another constituent element, the constituent element may be directly coupled or directly connected to the another constituent element, but yet another constituent element may be provided between the constituent element and the another constituent element. Further, when a constituent element is referred to as being “directly coupled” or “directly connected” to another constituent element, yet another constituent element may not be provided between the constituent element and the another constituent element. The terms used herein are merely used to describe specific example embodiments and do not limit the present disclosure. Expressions in the singular form should be understood to encompass expressions in the plural form unless the context clearly indicates otherwise. The term “includes,” “has” or the like are intended to include features, numeric characters, operations, operations, constituent elements, parts, or a combination thereof, and should be understood not to exclude one or more other features, numeric characters, operations, operations, constituent elements, parts, or a combination thereof, or additional features and the like. Terms a “first,” a “second,” and the like are used to distinguish a plurality of constituent elements from each other, and the order or importance of corresponding constituent elements is not limited by these terms. Unless otherwise defined, all technical and scientific terms used herein have the same meaning commonly understood by those skilled in the art to which the present disclosure pertains. In addition, the commonly-used predefined terms should be interpreted as consistent with the meanings of the context in the related art and should not be interpreted as having ideal or excessive formal meanings unless otherwise defined in this application.

When one constituent element “comprise or includes” another constituent element through the specification and the claims, this means that the one constituent element may further include other constituent elements, rather than excluding other constituent elements, unless other stated. Hereinafter, preferred example embodiments of the present disclosure will be described in detail with reference to the accompanying drawings.

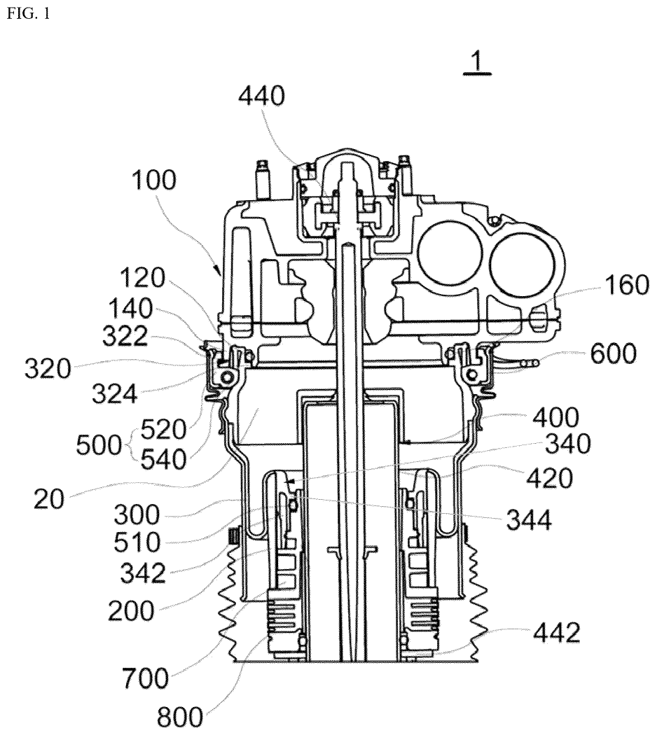

FIG. 1 is a cross-sectional view of an air spring according to an example embodiment of the present disclosure.

As shown in FIG. 1, an air spring 1 may be configured to include at least a top mount 100, a piston 200, a sleeve 300 which is air-tightly connected to the top mount 100 and the piston 200, and a damper 400. As an example, one end of the sleeve 300 may be air-tightly fixed to a lower portion of the top mount 100, and the other end of the sleeve 300 may be air-tightly fixed to the piston 200. The top mount 100, the piston 200 and the sleeve 300 form an operation space 20 filled with compressed air.

Hereinafter, a structure in which one end of the sleeve and the top mount are air-tightly fixed to each other, and a structure in which the other end of the sleeve and the piston are air-tightly fixed to each other will be described. Subsequently, a structure for preventing sealing rings from being worn in such air-tight fixing structures will be described.

### 1. For Structure in Which One End of Sleeve and Top Mount are Air-Tightly Fixed to Each Other

As shown in FIG. 1, a bead constraining member 500 according to an example embodiment of the present disclosure is a constituent element configured to constrain a bead 320 of the sleeve 300 in an axial direction (in other words, an up-down direction). Further, the bead constraining member 500 constrains the bead 320 of the sleeve 300 in a radial direction in cooperation with a lower surface of the top mount 100.

As an example, the bead constraining member 500 includes an axial extension portion 520 and a radially-inward extension portion 540 extending from one end of the axial extension portion 520 in a radially inward direction. The radially-inward extension portion 540 constrains the bead 320 of the sleeve 300 in the axial direction.

To this end, according to an example embodiment of the present disclosure, the bead 320 of the sleeve 300 may be formed to have a structure that protrudes outward from one end of the sleeve 300 in the radial direction. Thus, the bead 320 formed to protrude from the sleeve 300 in a radially outward direction is locked to the radially-inward extension portion 540 of the bead constraining member 500 in the axial direction, such that the bead 320 of the sleeve 300 is constrained by the bead constraining member 500 in the axial direction.

According to an example embodiment of the present disclosure, the top mount 100 may be configured to include a first downward extension portion 120 extending downward from the lower surface of the top mount 100, and a second downward extension portion 140 arranged to be spaced apart from the first downward extension portion 120 in the radially outward direction and extending downward from the lower surface of the top mount 100. In this configuration, the bead 320 of the sleeve 300 may be arranged between the first downward extension portion 120 and the second downward extension portion 140 and may be constrained by the first downward extension portion 120 and the second downward extension portion 140 in the radial direction.

As an example, the bead 320 of the sleeve 300 may be configured to include a reinforcing insert. By forming the sleeve 300 in an over-molding manner with the reinforcing insert 322 inserted into a mold, the bead 320 of the sleeve 300 may be formed such that the reinforcing insert 322 is at least partially embedded in the bead 320. The reinforcing insert 322 is partially embedded in the bead 320 of the sleeve 300 so that the reinforcing insert 322 may be configured to come into contact with the second downward extension portion 140 of the top mount 100 and the bead constraining member 500.

According to an example embodiment of the present disclosure, a sealing ring 160 in the form of an O-ring may be provided between the lower surface of the top mount 100 and the sleeve 300. Thus, the sleeve 300 may be air-tightly coupled to the top mount 100. As an example, the sleeve 300 includes a protruded portion 324 protruding in the radially inward direction. The sealing ring 160 may be installed in a space surrounded by an inner peripheral surface of the sleeve 300, the protruded portion 324 and the lower surface of the top mount 100.

According to an example embodiment of the present disclosure, in the state in which the bead 320 of the sleeve 300 has been constrained by the bead constraining member 500 in the axial direction or the radial direction, the bead 320 of the sleeve 300 may finally be fastened to the top mount 100 by the clamping ring 600.

### 2. For Structure in Which Other End of Sleeve and Piston are Air-Tightly Fixed to Each Other

As shown in FIG. 1, according to an example embodiment of the present disclosure, the damper 400 may include a damper tube 420 and a piston rod 440. One end of the piston rod 440 is fixed to the top mount 100. The piston rod 440 passes through the damper tube 420. The damper tube 420 is configured to be movable in the axial direction (in other words, the up-down direction) relative to the piston rod 440.

According to an example embodiment of the present disclosure, the piston 200 is mounted on the damper 400 and is configured to move in the axial direction (in other words, the up-down direction) together with the damper 400.

The piston 200 may be mounted directly on the damper tube 420. Alternatively, the piston 200 may be mounted on the damper tube 420 via an intermediate structure (for example, an adapter).

FIG. 1 shows an example embodiment in which a sealing ring seat 700 is used as the intermediate structure. As shown in FIG. 1, the damper tube 420 may be formed with a fixation flange 442 on its outer peripheral surface. The fixation flange 442 may be formed integrally with the damper tube 420. As an example, the fixed flange may be formed integrally with the damper tube 420 by welding.

The sealing ring seat 700 has a mounting surface on which a second sealing ring 510 in the form of an O-ring is mounted. The second sealing ring 510 is mounted on the mounting surface of the sealing ring seat 700. The sealing ring seat 700 basically has a cylindrical shape with a hollow. When the damper 400 is inserted into the hollow of the sealing ring seat 700 on which the second sealing ring 510 is mounted, the sealing ring seat 700 is supported by the fixation flange 442. The piston 200 is arranged on the sealing ring seat 700 and moves in the up-down direction together with the sealing ring seat 700. The second sealing ring 510 performs a function of sealing a gap between the sleeve 300 and the sealing ring seat 700.

As an example, a bead 340 of the sleeve 300 may be configured to include a reinforcing insert 342. By forming the sleeve 300 in an over-molding manner with the reinforcing insert 342 inserted into a mold, the bead 340 of the sleeve 300 may be formed such that the reinforcing insert 342 is at least partially embedded in the bead 340. The reinforcing insert 342 may be configured to be partially embedded in the bead 340 of the sleeve 300.

### 3. For Structure to Absorb Rotation of Damper

As described above, the damper 400 may be rotated with a steering operation by a driver. In the present disclosure, a structure in which relative rotation between the damper 400 and the piston 200 is allowed is provided. As an example, a torsion bushing 800 is provided between the sealing ring seat 700 and the fixation flange 442 of the damper 400 to absorb the rotation of the damper. On the other hand, as an amount of torsional rotation of the damper increases due to kinematic characteristics of a vehicle, the torsion bushing 800 is also twisted. This allows the rotation of the damper 400 relative to the piston 200.

In the structure for absorbing the rotation of the damper 400, the slip accompanied by the above-described relative rotation may occur in the first sealing ring 160 provided between one end of the sleeve 300 and the top mount 100, and the second sealing ring 510 provided between the sleeve 300 and the sealing ring seat 700. This may wear out the first sealing ring 160 and the second sealing ring 510.

### 4. For Structure to Prevent Wear of Sealing Ring

In the present disclosure, a first anti-wear structure is applied in the vicinity of the first sealing ring 160 so as to prevent the relative rotation between one end of the sleeve 300 and the top mount 100, and a second anti-wear structure is applied in the vicinity of the second sealing ring 510 so as to prevent the relative rotation between the other end of the sleeve 300 and the sealing ring seat 700. This prevents the slip from being generated in the first sealing ring 160 and the second sealing ring 510 due to the relative rotations, thereby reducing the risk of the wear of the sealing rings.

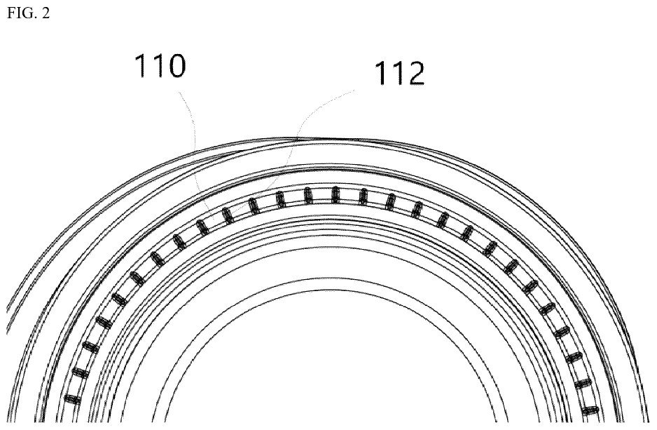

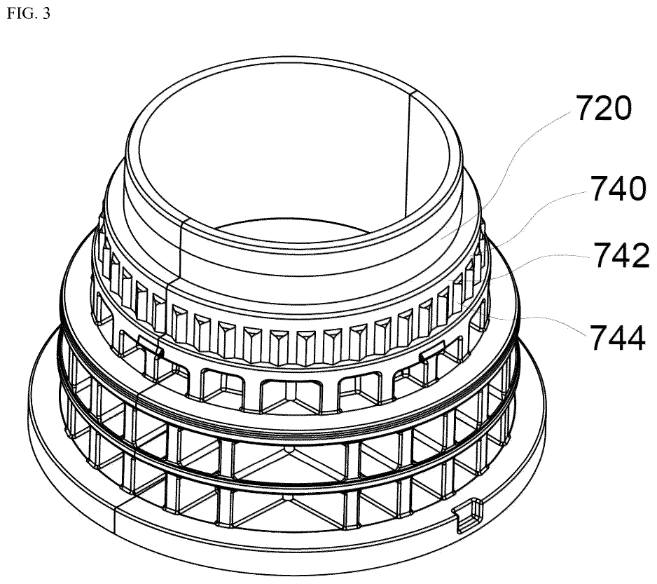

FIG. 2 shows a contact surface formed on the lower surface of the top mount according to an example embodiment of the present disclosure. FIG. 3 shows a sealing ring seat according to an example embodiment of the present disclosure.

Next, these example embodiments will be described in more detail with reference to FIGS. 2 and 3.

### A. For Anti-Wear Structure to prevent Wear of First Sealing Ring

According to an example embodiment of the present disclosure, as shown in FIG. 2, the top mount 100 may have a ring-shaped contact surface 110 with which the bead 320 of the sleeve 300 is brought into contact.

A plurality of protrusions 112 is formed on the contact surface 110 to protrude toward the bead 320. As the sleeve 300 is pressed against the contact surface 110 by a pressure of the compressed air in the sleeve 300, the sleeve 300 is compressed and deformed by the plurality of protrusions 112. This makes it possible to prevent the sleeve 300 and the contact surface 110 from rotating relative to each other.

As an example, the plurality of protrusions 112 may be arranged to be circumferentially spaced apart from each other along the contact surface 110. Each protrusion 112 may have a key shape extending in the axial direction and may be formed in a serration form.

According to an example embodiment of the present disclosure, the first sealing ring 160 may be provided between the bead 320 of the sleeve 300 and the lower surface of the top mount 100,

According to an example embodiment of the present disclosure, the top mount 100 may include the first downward extension portion 120 extending downward from the lower surface of the top mount 100, and the second downward extension portion 140 arranged to be spaced apart from the first downward extension portion 120 in the radially outward direction and extending downward from the lower surface of the top mount 100. The bead 320 may be arranged between the first downward extension portion 120 and the second downward extension portion 140. The contact surface 110 may be formed on the lower surface of the top mount! 00 between the first downward extension portion 120 and the second downward extension portion 140.

According to an example embodiment of the present disclosure, the sleeve 300 may further include the protruded portion 324 protruding in the radially inward direction. The first sealing ring 160 may be installed in the space surrounded by the inner peripheral surface of the sleeve 300, the protruded portion 324 and the lower surface of the top mount 100.

With the aforementioned structure, the sleeve 300 and the contact surface 110 are prevented from rotating relative to each other in the vicinity of the first sealing ring 160. This prevents the slip from being generated in the first sealing ring 160 due to such a relative rotation, thereby reducing the risk of the wear of the first sealing ring 160.

### B. For Anti-Wear Structure to Prevent Wear of Second Sealing Ring

According to an example embodiment of the present disclosure, the sealing ring seat 700 has a mounting surface on which the second sealing ring 510 is mounted, and a contact surface 742. The bead 340 may be provided between the sealing ring seat 700 and the piston 200. The contact surface 742 may have a ring shape in contact with the bead 340 of the sleeve 300.

The contact surface 742 has a plurality of protrusions 744 formed to protrude toward the bead 340. As the sleeve 300 is pressed against the contact surface 742 by the pressure of the compressed air in the sleeve 300, the sleeve 300 is compressed and deformed by the plurality of protrusions 744. This makes it possible to prevent the sleeve 300 and the contact surface 742 from rotating relative to each other.

As an example, the plurality of protrusions 744 may be arranged to be circumferentially spaced apart from each other along the contact surface 742. Each protrusion 744 may have a key shape extending in the axial direction and may be formed in a serration form.

According to an example embodiment of the present disclosure, the sealing ring seat 700 may include a first outer-diameter portion 720 having a first outer diameter and a second outer-diameter portion 740 having a second outer diameter greater than the first outer diameter.

The first outer-diameter portion 720 and the second outer-diameter portion 740 are continuously arranged to form a stepped portion. The mounting surface may be formed at the stepped portion. The contact surface 742 may be formed on an outer peripheral surface of the second outer-diameter portion 740.

According to an example embodiment of the present disclosure, the sleeve 300 may further include a radially-inward protruded portion 344 protruding in the radially inward direction. The second sealing ring 510 may be installed in a space surrounded by the inner peripheral surface of the sleeve 300, the radially-inward protruded portion 344 and the stepped portion of the sealing ring seat 700.

With the aforementioned structure, the sleeve 300 and the contact surface 742 are prevented from rotating relative to each other in the vicinity of the second sealing ring 510. This prevents the slip from being generated in the second sealing ring 510 due to such a relative rotation, thereby reducing the risk of the wear of the second sealing ring 510.

### EXPLANATION OF REFERENCE NUMERALS

1: Air spring
20: Operation space
100: Top mount
110: Contact surface
112: Protruded portion
120: First downward extension portion
140: Second downward extension portion
160: First sealing ring
200: Piston
300: Sleeve
320: Bead
322: Reinforcing insert
324: Radially-inward protruded portion
340: Bead
342: Reinforcing insert
344: Radially-inward protruded portion
400: Damper
420: Damper tube
440: Piston rod
442: Fixation flange
500: Bead constraining member
510: Second sealing ring
520: Axial extension portion
540: Radially-inward extension portion
700: Sealing ring seat
720: First outer-diameter portion
740: Second outer-diameter portion
742: Contact surface
744: Protrusion
800: Torsion bushing

What is claimed is:

1. An air spring for a vehicle, comprising:
a sleeve (300); and
an end member to which beads (320) and (340) formed at one end of the sleeve (300) are coupled,
wherein the end member has ring-shaped contact surfaces (110) and (742) configured to come into contact with the beads (320) and (340),
wherein at least one protrusion (112) and at least one protrusion (744) are formed in the contact surfaces (110) and (742) to protrude toward the beads (320) and (340), respectively, and
wherein, when the sleeve (300) is pressed against the contact surfaces (110) and (742) by a pressure of compressed air in the sleeve (300), the sleeve (300) is compressed and deformed by the at least one protrusion (112) and the at least one protrusion (744) so that the sleeve (300) and the contact surfaces (110) and (742) are prevented from rotating relative to each other.

2. The air spring of claim 1, wherein the at least one protrusion (112) and the at least one protrusion (744) includes a plurality of protrusions (112) and a plurality of protrusions (744), which are arranged to be spaced apart from each other in a circumferential direction along the contact surfaces (110) and (742), respectively.

3. The air spring of claim 2, wherein each of the plurality of protrusions (112) and each the plurality of protrusions (744) have a key shape extending in an axial direction and are formed in a serration form.

4. The air spring of claim 1, wherein sealing rings (160) and (510) are provided between the beads (320) and (340) of the sleeve (300) and the end member, respectively.

5. The air spring of claim 1, wherein the end member is a top mount (100),
wherein the top mount (100) includes a first downward extension portion (120) extending downward from a lower surface of the top mount (100), and a second downward extension portion 140 arranged to be spaced apart from the first downward extension portion (120) in a radially outward direction and extending downward from the lower surface of the top mount (100),
wherein the bead (320) is arranged between the first downward extension portion (120) and the second downward extension portion (140), and
wherein the contact surface (110) is formed on the lower surface of the top mount (100) between the first downward extension portion (120) and the second downward extension portion (140).

6. The air spring of claim 4, wherein the sleeve (300) further includes a radially-inward protruded portion (324) protruding in a radially inward direction, and
wherein the sealing ring (160) is installed in a space surrounded by an inner peripheral surface of the sleeve (300), the radially-inward protruded portion (324) and the lower surface of a top mount (100).

7. The air spring of claim 1, wherein the end member is a piston constituent element.

8. The air spring of claim 7, wherein the piston constituent element includes a piston (200) and a sealing ring seat (700),
wherein the sealing ring seat (700) has a mounting surface on which a sealing ring (510) is mounted, and the contact surface (742), and
wherein the bead (340) is provided between the sealing ring seat (700) and the piston (200).

9. The air spring of claim 8, wherein the sealing ring seat (700) includes a first outer-diameter portion (720) having a first outer diameter and a second outer-diameter portion (470) having a second outer diameter greater than the first outer diameter,
wherein the first outer-diameter portion (720) and the second outer-diameter portion (740) are continuously arranged to form a stepped portion,
wherein the mounting surface is formed at the stepped portion, and
wherein the contact surface (7420 is formed on an outer peripheral surface of the second outer-diameter portion (740).

10. The air spring of claim 9, wherein the sleeve (300) further includes a radially-inward protruded portion (344) protruding in a radially inward direction, and
wherein the sealing ring (510) is provided in a space surrounded by an inner circumferential surface of the sleeve (300), the radially-inward protruded portion (344) and the stepped portion of the sealing ring seat (700).
